(19) United States
(12) Patent Application Publication
(10) Pub. No.: US 2008/0214249 A1
(43) Pub. Date: Sep. 4, 2008

(54) Sleep Mode Controlling Apparatus and Method in Cellular System

(75) Inventors: Jae-Heung Kim, Daejeon (KR); Byung-Han Ryu, Daejeon (KR); Seung-Chan Bang, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/064,959

(22) PCT Filed: Aug. 23, 2006
(86) PCT No.: PCT/KR2006/003309

§ 371 Date: Feb. 26, 2008

(30) Foreign Application Priority Data
Aug. 26, 2005 (KR) 10-2005-0078872
Nov. 24, 2005 (KR) 10-2005-0112766

(51) Int. Cl. H04B 1/38

(52) U.S. Cl. 455/574

(57) ABSTRACT

In a cellar system providing various packet services, sleep mode operation of a terminal in an idle state is controlled. The cellular system determines a discontinuous receiving (DRX) period according to a QoS of a packet service provided to the terminal, and runs the sleep mode according to the determined DRX period. The cellular system runs the sleep mode divided into shallow sleep duration and deep sleep duration. With this manner, a paging delay to the terminal and a power consumption of the terminal may be reduced.

### TECHNICAL FIELD

The present invention relates to a sleep mode controlling apparatus and method in a cellular system. More particularly, the present invention relates to a sleep mode controlling method in a 3rd Generation Partnership Project (3GPP) system.

### BACKGROUND ART

In order to reduce terminal power consumption, the cellular system allows a terminal to be operated in a sleep mode by transiting the terminal into an idle state when the terminal has no data to transmit/receive. During the sleep mode operation, the terminal wakes up at a paging time of respective constant periods and confirms a paging channel, and again performs a sleep mode operation with the same period in the case that the terminal is not transited into another state, excluding the idle state.

Meanwhile, the cellular system has been developed to provide various packet services as well as a circuit service. The circuit service has an advantage in that it is easy for the terminal to perform the sleep mode operation because the terminal may precisely recognize a service end point, while the packet services have a drawback in that it is difficult for the terminal to perform the sleep mode operation because it may not precisely recognize a service end point according to a burst packet data characteristic. In addition, the packet services may have a drawback in that a paging delay may occur or power consumption may be increased in the case that the terminal wakes up every fixed paging time and confirms the paging channels, because each respective service may have a different quality of service (hereinafter QoS) or the respective terminal may provide different services according to capabilities.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a sleep mode controlling apparatus and method in a cellular system having advantages of determining a sleep mode operation according to packet service type or terminal-capability.

In order to solve such a project, the sleep mode controlling apparatus and method according to an exemplary embodiment of the present invention determines a sleep mode parameter according to QoS of the packet service.

### Technical Solution

An exemplary embodiment of the present invention provides a terminal sleep mode controlling method in a cellular system. The terminal sleep mode controlling method includes establishing a first sleep mode parameter corresponding to at least one of a quality of service (QoS) of a packet service provided to the terminal and a capability of the terminal; transiting the terminal from an active state to an idle state; and controlling the terminal to perform a paging channel monitoring whenever a time determined by the first sleep mode parameter in the sleep mode is passed.

The first sleep mode parameter may include a parameter for determining a discontinuous reception (DRX) period, and the paging channel monitoring duration may be performed in the sleep mode whenever the DRX period is passed.

The controlling step may include establishing the sleep mode to be run by being divided into shallow sleep duration and deep sleep duration, the deep sleep duration performing the paging channel monitoring less often than the shallow sleep duration.

The DRX period may be increased during the shallow sleep duration whenever a predetermined duration is passed. In addition, the first sleep mode parameter may include a DRX period increase value and a DRX period increase coefficient, and when the DRX period is increased from a first DRX period to a second DRX period during the shallow sleep duration the second DRX period may be determined by summing the first DRX period with a product of the DRX period increase value and the DRX period increase coefficient.

The first sleep mode parameter may include a DRX period maintenance constant, the DRX period of the shallow sleep duration has the same value while the DRX period maintenance constant occurs, and the predetermined duration is given as a duration in which the DRX period maintenance constant occurs.

The establishing step may include establishing the first sleep mode parameter considering at least one of the QoS of the packet service and the terminal quality by means of signaling with the terminal.

Another exemplary embodiment of the present invention provides method for controlling a terminal in a cellular system providing various packet services to the terminal. The terminal controlling method includes ending a session of a packet service provided to the terminal and transiting the terminal to an idle state; controlling the terminal to be operated in a first sleep duration, and controlling the terminal to be operated in a second sleep duration, the second sleep duration rarely monitoring a paging channel compared to the first sleep duration. At this time, during the first sleep duration, the terminal may monitor the paging channel whenever a first period is passed and the first period is increased as the first sleep duration is passed, and during the second sleep duration, the terminal may monitor the paging channel whenever the second sleep duration, which is longer than the first sleep duration, is passed, and the second sleep duration may be performed after the first sleep duration ends.

Yet, another exemplary embodiment of the present invention provides sleep mode controlling apparatus of a cellular system providing various packet services to a terminal, the sleep mode controlling apparatus, and the sleep mode control apparatus includes a state controller and a parameter setting unit. The state controller may transit the terminal from an active state to an idle state and control the terminal to perform a sleep mode operation in the idle state, and the parameter setting unit may establish at least one parameter necessary for the sleep mode operation based on a quality of service (QoS) of the packet service provided to the terminal when the terminal is transited into the idle state.

Yet, another exemplary embodiment of the present invention provides base station of a cellular system comprising a controller for controlling a sleep mode.

Yet, another exemplary embodiment of the present invention provides a method for performing a sleep mode operation for a terminal provided various packet services from a cellular system. The sleep mode operation performing method includes receiving a sleep mode parameter determined according to QoS of the packet service, monitoring a paging channel when a first period is passed, the first period determined by the sleep mode parameter during a first sleep duration, and monitoring the paging channel when a second period is passed, the second period determined by the sleep mode parameter during a second sleep duration after the established first sleep duration ends.

### BRIEF DESCRIPTION OF THE DRAWINGS

FIG. 1 is a schematic view of a cellular system according to an exemplary embodiment of the present invention.

FIG. 2 is a schematic view of a terminal state managed by a cellular system according to an exemplary embodiment of the present invention.

FIG. 3 shows a packet data characteristic in a packet service.

FIG. 4 is a schematic block diagram of a sleep mode controlling apparatus of a cellular system according to an exemplary embodiment of the present invention.

FIG. 5 is a flowchart showing a method for transiting a terminal from a transmit state to a stand-by state according to an exemplary embodiment of the present invention.

FIG. 6 shows a relation between terminal states and packet data occurrence.

FIG. 7 is a flowchart showing a method for transiting a terminal from an active state to an idle state according to an exemplary embodiment of the present invention.

FIG. 8 and FIG. 9 show a terminal sleep mode according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

When it is described that an element is coupled to another element, the element may be directly coupled to the other element or coupled to the other element through a third element.

A sleep mode controlling apparatus and method in a cellular system according to exemplary embodiments of the present invention will be described with reference to the accompanying figures.

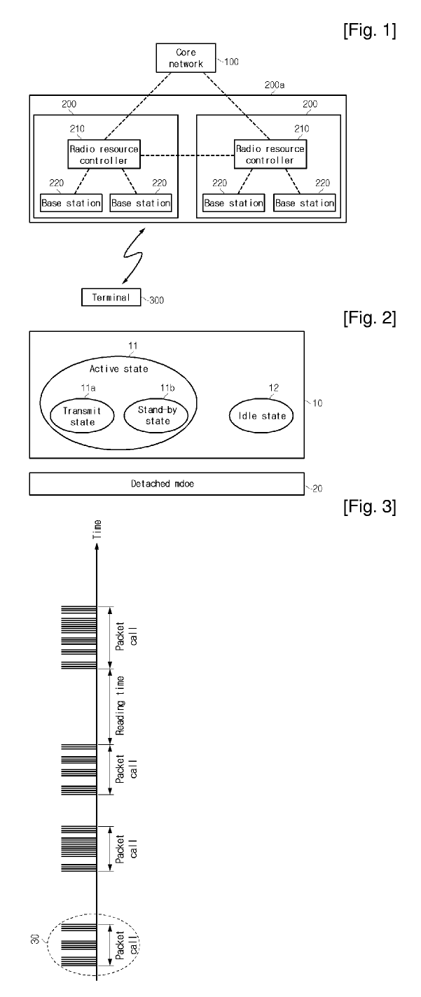

FIG. 1 is a schematic view of a cellular system according to an exemplary embodiment of the present invention.

As shown in FIG. 1, a cellular system according to an exemplary embodiment of the present invention includes a core network 100 and at least one wireless network subsystem 200, and a series of wireless network subsystems 200 form a wireless access network 200a by being coupled through interfaces. Such a wireless access network 200a is coupled to the core network 100, and each wireless network subsystem 200 includes a radio resource controller 210 and at least one base station 220 under a control of the radio resource controller 210. Respective base stations 220 manage at least one cell (not shown), and an inner-cell terminal 300 may be coupled to the wire less access network 200a through the corresponding base station 220.

Dislike FIG. 1, the cellular system may not include the radio resource controller 210. In this case, the radio resource control functions of the radio resource controller 210 are distributed between the core network 100 and the base station 220.

When the cellular system according to an exemplary embodiment of the present invention is, for example, a Universal Mobile Telecommunication System (UMTS) of the 3GPP, the wireless access network 200a may be formed as a UMTS terrestrial radio access network (UTRAN), the radio resource controller 210 may be formed as a radio network subsystem (RNS), and the base station 220 may be formed as a Node B. Herein, the interface in the UTRAN may be formed in an asynchronous transmit mode (ATM) scheme. The terminal 300 may correspond to a user equipment (UE) formed with a UMTS Subscriber Identity Module (USIM) and a mobile equipment (ME).

Now, the terminal states managed by a cellular system and a method for transiting such terminal states according to an exemplary embodiment of the present invention will be described with reference to FIG. 2 to FIG. 9.

First, the terminal states managed by the cellular system according to an exemplary embodiment of the present invention will be described with reference to FIG. 2 and FIG. 3. FIG. 2 is a schematic view of terminal states managed by a cellular system according to an exemplary embodiment of the present invention and FIG. 3 shows packet data characteristics in a packet service.

As shown in FIG. 2, the cellular system defines a state of the terminal 300 and manages the same so as to efficiently run a radio resource of the base station 220. In more detail, the cellular system defines a state of the terminal 200 as an attached mode 10 or a detached mode 20, in which the attached mode 10 is a terminal state registered through the base station 220 and the detached mode 20 is a terminal state which may not be registered either through the base station 220 and or in the core network 100. The attached mode 10 is divided into an active state 11 and an idle state 12 according to a packet service state. The active state 11 is a state in which the terminal 300 may have a radio resource allocated to transmit/receive packet data through a control of the base station 220, and may be divided into a transmit state 11a and a stand-by state 11b according to whether it has a radio resource. The stand-by state 11b is a state in which the terminal 300 has no data to be transmitted or received due to the burst packet data characteristic, or other reasons, and in which it maintains only a minimum of control channels with the base station 220. And, the terminal 300 of the stand-by state 11b performs a power saving operation by being transited into the transmit state 11a or being maintained at the stand-by state 11b according to bust characteristics of the packet data. The idle state 12 is a state in which the terminal 300 may be coupled to the wireless access network 200a, but may not occupy a radio resource for transmitting/receiving data. Such a terminal 300 in the idle state 12 performs a sleep mode operation so as to reduce power consumption.

As such, the cellular system may manage the state of the terminal 300 by defining the same, and may transit the state of the terminal 300 according to the packet service state. For example, according to the packet data characteristic, a packet call 30 may be generated into a burst as shown in FIG. 3. When the packet call 30 occurs, the base station 220 allocates a radio resource to the terminal 300 in the active state 11 and transmits the packet data to the terminal 300 by occupying the allocated radio resource. In this case, the cellular system defines the terminal 300 as being in the transmit state 11a. In addition, when there is no packet data to be transmitted to the terminal 300 in a reading time of FIG. 3, the cellular system may transit the terminal 300 into the stand-by state 11b. When sessions of all the packet services to the terminal 300 are finished, the cellular system may transit the terminal 300 into the idle state 12.

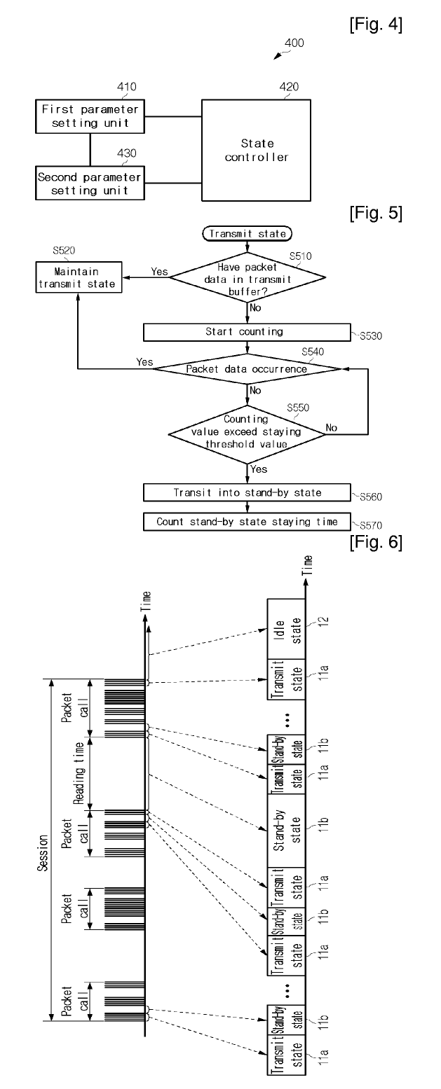

Next, a method for controlling a terminal state transition in a cellular system according to an exemplary embodiment of the present invention will be described with reference to FIG. 4 to FIG. 9. FIG. 4 is a schematic block diagram of a sleep mode controlling apparatus 400 in a cellular system according to an exemplary embodiment of the present invention. Such a sleep mode controlling apparatus 400 may be formed on the wireless network subsystem 200, particularly, the base station 220 of the wireless network subsystem 200, or may distribute some functions to the radio resource controller 210.

As shown in FIG. 4, the sleep mode controlling apparatus 400 in the cellular system according to an exemplary embodiment of the present invention includes a first parameter setting unit 410, a state controller 420, and a second parameter setting unit 430. The state controller 420 may be formed in a scheduler (not shown) of the base station 220, or may be separate from the scheduler such that the information may be exchanged between the state controller 420 and the scheduler. The first parameter setting unit 410 may be performed by the radio resource control function and the second parameter setting unit 430 may be performed by the scheduler via the radio resource control function.

The first parameter setting unit 410 establishes a sleep mode parameter according to a type of QoS of the packet service or the respective terminal capability, forms system information using the established sleep mode parameter, and broadcasts the system information through a broadcasting channel to the entire cell. The state controller 420 determines the packet data stored at the respective transmit buffers (not shown) of the base station 220 and the terminal 300. In addition, the state controller 420 controls the state of the terminal 300 according to the packet service state between the wireless network subsystem 200 and the terminal 300. When the state controller 420 transits the terminal 300 into the idle state 12, the second parameter setting unit 430 establishes a sleep mode parameter for a sleep mode operation and informs the same to the terminal 300.

The first parameter setting unit 410 establishes a sleep mode parameter for the respective QoS types of the packet services and allows the sleep mode parameter to be included in the system information, and the second parameter setting unit 430 establishes a sleep mode parameter for the corresponding terminal 300 according to the terminal-supportable QoS of the packet service. When the first and second parameter setting units 410 and 430 establish a sleep mode parameter, the terminal-capability may also be considered. The terminal 300 may perform a sleep mode operation by dividing the sleep mode operation into shallow sleep duration and deep sleep duration by means of such a sleep mode parameter. The shallow sleep duration is a duration during which a paging channel is relatively often monitored and the deep sleep duration is a duration during which the paging channel is relatively rarely monitored.

In more detail, as shown in Table 1, the sleep mode parameter established by the first parameter setting unit 410 may include a minimum DRX period, a DRX period increase coefficient, a DRX period maintenance constant, a DRX period increase value, a length of the shallow sleep duration, a deep sleep DRX period, a transmit state staying threshold value, and a stand-by state staying threshold value. In addition, the sleep mode parameter established by the second parameter setting unit 430 may include a DRX period initial value, a DRX period increase coefficient, a DRX period maintenance constant, a DRX period increase value, a shallow sleep duration, and a deep sleep duration.

TABLE 1

| Sleep mode | |
|---|---|
| parameter | Definition |
| Minimum DRX | A minimum value of a coefficient for setting a |
| period | terminal DRX period |
| DRX period | A coefficient value for indicating an increase |
| increase coefficient | amount when a terminal DRX period is increased |
| | during the shallow sleep duration |
| DRX period | A value for indicating a terminal DRX period |
| increase amount | increase amount during the shallow sleep duration. |
| DRX period | A value established as a counter or time so as |
| maintenance | to maintain a constant period, when DRX period |
| constant | (sleep duration) is increased by the DRX period |
| | increase coefficient in the shallow sleep duration |
| Length of shallow | A duration for a terminal performing a DRX |
| sleep duration | period increase operation according to the |
| | predetermined DRX period increase coefficient |
| Deep sleep DRX | A predetermined DRX period for the sleep |
| period | mode operation of the deep sleep duration, in which |
| | the shallow sleep duration ends |
| Transmit state | A threshold value capable of staying in the |
| staying threshold | transmit state without packet data to be transmitted |
| value | to the transmit buffer of the base station and the |
| | terminal |
| Stand-by state | A threshold value capable of staying in the |
| staying threshold | stand-by state without or impossible recognizing the |
| value | end of the packet service |

How such a sleep mode controlling apparatus 400 transits the state of the terminal 300 will be described with reference to FIG. 5 to FIG. 9.

First, how such a sleep mode controlling apparatus 400 transits the terminal 300 from the transmit state 11a to the stand-by state 11b will be described with reference to FIG. 5 and FIG. 6.

FIG. 5 is a flowchart showing a method for transiting the terminal from a transmit state 11a to a stand-by state 11b according to an exemplary embodiment of the present invention and FIG. 6 illustrates a relation between a terminal state and a packet data occurrence. As described above, both the transmit state 11a and the stand-by state 11b are lower states of the active state 11, which has a session established to provide a packet service between the terminal 300 and the wireless network subsystem 200.

As shown in FIG. 5, the state controller 420 determines whether the respective transmit buffers of the base station 220 and the terminal 300 have packet data (S510), and the state controller 420 maintains the terminal 300 at the transmit state 11a, as in FIG. 6, when the transmit buffer has packet data (S520). When the desired packet data have been transmitted, and accordingly, the state controller 420 determines that the respective buffers are empty, the state controller 420 starts a count from a time point at which the transmit buffers are empty (S530). And then, the state controller 420 monitors whether any packet data to be transmitted are generated (S540). In the case that there are no packet data to be transmitted generated before the count value exceeds the transmit state staying threshold value (S550), the state controller 420 transits the terminal 300 into the stand-by state as shown in FIG. 6 (S560). The state controller 420 counts a staying time in the stand-by state 11b when the terminal 300 is transited into the stand-by state 11b (S570). At the step S540, when the packet data to be transmitted is generated before the count value exceeds the transmit state staying threshold value, the state controller 420 maintains the terminal 300 in the transmit state (S520), and then the steps S510 and S570 are repeated.

In addition, the state controller 420 may transit the terminal 300 into the stand-by state 11b when the wireless environment between the base station 220 and the terminal 300 is deteriorated and accordingly it is impossible to allocate the radio resource, or due to other reasons. When the packet data is generated in the stand-by state 11b and input into the transmit buffers of the base station 220 or the terminal 300, the state controller 420 transits the terminal 300 from the stand-by state 11b to the transmit state 11a.

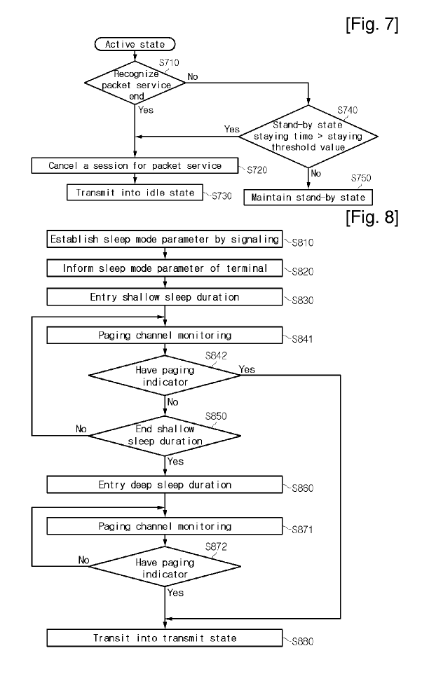

Next, how the sleep mode controlling apparatus 400 transits the terminal 300 from the active state 11, that is, the transmit state 11a or the stand-by state 11b, to the idle state 12 will be described with reference to FIG. 6 and FIG. 7.

FIG. 7 is a flowchart showing a method for transiting a terminal 300 from an active state 11 to an idle state 12 according to an exemplary embodiment of the present invention. Particularly, in FIG. 7, it is assumed that the terminal 300 is in the stand-by state 11b within the active state 11. In the case that the terminal 300 is in the transmit state 11a, steps S740 and S750 need not be performed.

As shown in FIG. 7, the state controller 420 recognizes a packet service end by a signal started from an application layer (not shown) for the packet service (S710), the sleep mode controlling apparatus 400 cancels a session for the packet service established between the terminal 300 and the wireless network subsystem 200 (S720), and then transits the terminal 300 into the idle state 12, as in FIG. 6 (S730). When the state controller 420 does not recognize the packet service end, it determines whether the stand-by state staying time exceeds the stand-by state staying threshold value of the packet service provided to the terminal 300 (S740), the stand-by state staying time being counted from when the terminal 300 is transited into the stand-by state 11b. At this time, if the stand-by state staying time exceeds the stand-by state staying threshold value, the state controller 420 cancels a session and transits the terminal 300 into the idle state 12 (S730). If the stand-by state staying time does not exceed the stand-by state staying threshold value, the state controller 420 maintains the terminal 300 in the stand-by state 11b (S750).

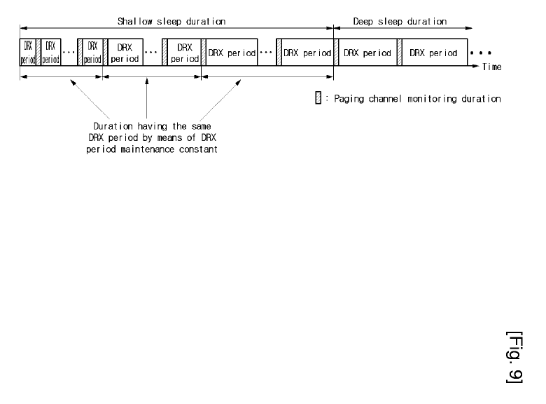

As such, the sleep mode controlling apparatus 400 may transit the terminal 300 from the active state 11 to the idle state 12. The sleep mode controlling apparatus 400 may transit the terminal 300 into the idle state 12 according to a request of the terminal 300 or for other reasons. When the terminal 300 is transited into the idle state 12, the terminal 300 performs a sleep mode operation as shown in FIG. 6. Now, a method for controlling the sleep mode operation will be described with reference to FIG. 8 and FIG. 9. FIG. 8 and FIG. 9 show a terminal sleep mode operation according to an exemplary embodiment of the present invention.

As shown in FIG. 8, when the terminal 300 is transited into the idle state 12 under a control of the controller 420, the second parameter setting unit 430 establishes a sleep mode parameter for the terminal 300 by signaling with the terminal 300 (S810), and informs the established sleep mode parameter to the terminal 300 (S820). The second parameter setting unit 430 may establish the sleep mode parameter considering the QoS of the provided packet service and the capability of the terminal 300. As described above, the sleep mode parameter includes a DRX period initial value, a DRX period increase level, a shallow sleep duration, and a deep sleep DRX period. The DRX period increase level includes a DRX period maintenance constant, a DRX period increase coefficient, and a DRX period increase value.

At this time, the second parameter setting unit 430 may differently establish a sleep mode parameter according to whether the packet service provided to the terminal 300 is a real-time service or a non real-time service. In addition, the second parameter setting unit 430 may establish a sleep mode parameter according to such statistic characteristics as packet data generation and a session establishment challenge. For example, in the case of a voice service, a large part of the session is used for a new voice service after the service ends. Accordingly, the second parameter setting unit 430 may establish the DRX period increase value and the DRX period increase coefficient as small values. In addition, in the case of such a best effort service as the Internet, a large part of the session is not used for a long time after being connected, and so the second parameter setting unit 430 may establish the DRX period increase value and the DRX period increase coefficient as large values.

As such, after the terminal 300 receives a sleep mode parameter, it enters a sleep mode of the shallow sleep duration as in FIG. 9 (S830), and performs a paging channel monitoring for monitoring paging information whenever the DRX period is passed during the shallow sleep duration (S841). That is, the paging times are repeated whenever the DRX period is passed. At this time, the initial DRX period [DRX_period 0] is established as the DRX period initial value determined by a negotiation with the terminal 300 at the step S710. The DRX period is increased whenever a duration indicated by the DRX period maintenance constant (hereinafter, “DRX period maintenance duration”) is passed, and the DRX period has the same value during the DRX period maintenance duration. In addition, when the first or second parameter setting unit 410 or 430 establishes the DRX period maintenance duration as a duration in which the DRX period is performed once, the DRX period is increased whenever the paging channel monitoring duration is performed.

At this time, the DRX period [DRX_period(n+1)] of (n+1)-th DRX period maintenance duration is determined by Equation 1.

(Equation 1)

DRX_period(n+1)=DRX_period(n)+ΔDRX·DRX_{—}C

Herein, the DRX_period(n) is a DRX period of n-th DRX period maintenance duration, the DRX_period 0 is a DRX period of an initial DRX period maintenance duration as a DRX period initial value, ADRX is a DRX period increase value, DRX_C is a DRX period increase coefficient, and n is an integer higher than 0.

Referring to Equation 1, the DRX period becomes longer when the DRX period increase coefficient or the DRX period increase value is established to be large, while the DRX period becomes shorter when the DRX period increase coefficient or the DRX period increase value is established to be small. For example, in the case of a large number of challenges to the new services, the DRX period is established to be short and the DRX period maintenance constant is established to be large, and accordingly, the terminal may often monitor the paging channels so that the paging delay may be reduced. In the case of the service not being used for a long time after access, the DRX period is established to be long, and accordingly, the terminal may rarely monitor the paging channel so that the power consumption may be reduced.

At this time, if the terminal 300 is established in the idle state 12 and there is no signaling between the terminal 300 and the sleep mode controlling apparatus 400, the terminal 300 performs a sleep mode operation by the sleep mode parameter included in the system information initially transmitted through the broadcasting channel. In this case, the DRX period initial value may be established as a minimum DRX period value.

And then, during the paging channel monitoring duration, the terminal 300 checks the existence of the paging indicator transmitted from the base station 220 (S842). When the terminal does not detect the paging indicator before the predetermined shallow sleep duration ends (S850) or the terminal 300 does not try for a packet service start to the base station 220, the terminal enters the deep sleep duration of the sleep mode, as in FIG. 9 (S860). And then, the terminal 300 performs a sleep mode operation during the established deep sleep DRX period. That is, whenever the established deep sleep DRX period is passed, the terminal 300 performs a paging channel monitoring (S871) and checks for the existence of the paging indicator (S872).

When the terminal 300 detects the paging indicator transmitted from the base station 220 during the paging channel monitoring duration of the shallow sleep duration or the deep sleep duration, the state controller 420 of the sleep mode controlling apparatus 400 transits the terminal 300 into the transmit state 11a (S880). That is, the state controller 420 establishes a session for providing a packet service between the base station 220 and the terminal 300. Also, when the terminal 300 tries for a packet service start, the state controller 420 transits the terminal 300 into the transmit state 11a.

According to an exemplary embodiment of the present invention, when the DRX period increase coefficient is established to be an integer higher than 1, the DRX period is continuously increased whenever the DRX period maintenance duration is passed during the shallow sleep duration. At this time, the sleep mode controlling apparatus 400 establishes at least one of the DRX period maintenance duration, the DRX period initial value, the DRX increase coefficient, and the DRX period increase value for the respective QoS types of the packet services, and thus may differently run a sleep duration for the respective QoS types of the packet services. In addition, the shallow sleep duration length and/or the deep sleep DRX period of the deep sleep duration may be established according to the types of QoS of the packet services.

In addition, according to an exemplary embodiment of the present invention, the DRX period of the shallow sleep duration is established to be shorter than that of the deep sleep duration, and accordingly, in the initial period of the idle duration, the terminal 300 may relatively often monitor a paging channel. In addition, the sleep mode controlling apparatus 400 controls the terminal 300 not to be operated during the shallow sleep duration, but to be operated during the deep sleep duration occasionally. In this case, the second parameter setting unit 430 establishes the length of the shallow sleep duration as ‘0’ and informs it to the terminal 300.

According to an exemplary embodiment of the present invention, it is one example that the sleep mode controlling apparatus 400 is formed in the wireless network subsystem 200 of FIG. 1. Accordingly, in the case that the radio resource control function for controlling the terminal in the idle state is formed on an upper layer of the base station of FIG. 1, the radio resource control function of the upper layer of the base station 220 may control a terminal sleep mode operation through the base station 220 of the wireless access network 200a. In addition, the sleep mode controlling apparatus 400 according to an exemplary embodiment of the present invention may be applied to other types of cellular systems as well as the cellular system of FIG. 1.

### INDUSTRIAL APPLICABILITY

The constituent elements described in an exemplary embodiment of the present invention may be realized as a hardware formed with such a logic element as at least one digital signal processor (DSP), a processor, a controller, an application specific integrated circuit (ASIC), a field programmable gate array (FPGA), other electronic apparatuses, or a combination thereof. According to an exemplary embodiment of the present invention, at least partial functions and processes may be realized by means of software. The software may be written in a recoding medium. According to an exemplary embodiment of the present invention, the constituent elements, functions, and processes may be realized by the combination of the hardware and the software.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment of the present invention, the sleep mode operations may be differently run depending on the type of packet service, QoS, and terminal capability, and thus the paging delay may be minimized and the power consumption may be reduced.

1. A method for controlling a terminal sleep mode in a cellular system, the terminal sleep mode controlling method comprising:
establishing a first sleep mode parameter corresponding to at least one of a quality of service (QoS) of a packet service provided to the terminal and a capability of the terminal;
transiting the terminal from an active state to an idle state; and
controlling the terminal to perform a paging channel monitoring duration whenever a time determined by the first sleep mode parameter is passed in the sleep mode.

2. The sleep mode controlling method of claim 1, wherein the first sleep mode parameter includes a parameter for determining a discontinuous reception (DRX) period, and the paging channel monitoring duration is performed whenever the DRX period is passed in the sleep mode.

3. The sleep mode controlling method of claim 2, wherein the controlling step includes establishing the sleep mode to be run by dividing the sleep mode into shallow sleep duration and deep sleep duration, the deep sleep duration performing the paging channel monitoring duration less often than the shallow sleep duration.

4. The sleep mode controlling method of claim 3, wherein the DRX period is increased during the shallow sleep duration each time a predetermined duration is passed.

5. The sleep mode controlling method of claim 3, wherein the first sleep mode parameter includes a DRX period increase value and a DRX period increase coefficient, and when the DRX period in the shallow sleep duration is increased from a first DRX period to a second DRX period, the second DRX period is determined by summing the first DRX period with a product of the DRX period increase value and the DRX period increase coefficient.

6. The sleep mode controlling method of claim 5, wherein the first sleep mode parameter includes a DRX period maintenance constant, the DRX period of the shallow sleep duration has the same value while the DRX period maintenance constant occurs, and the predetermined duration is given as a duration in which the DRX period maintenance constant is provided.

7. The sleep mode controlling method of claim 5, wherein the first sleep mode parameter further includes a DRX period minimum value for determining an initial DRX period of the shallow sleep duration.

8. The sleep mode controlling method of claim 3, wherein the first sleep mode parameter further includes the DRX period of the deep sleep duration.

9. The sleep mode controlling method of claim 3, wherein the first sleep mode parameter further includes a length of the shallow sleep duration, and the controlling step includes establishing the terminal to enter a deep sleep duration when there is no terminal-paging indicator provided to the terminal and there is no terminal-packet service start challenge before the shallow sleep duration ends.

10. The sleep mode controlling method of claim 3, wherein the establishing step includes establishing the length of the shallow sleep duration as ‘0’.

11. The sleep mode controlling method of claim 1, wherein the establishing step includes establishing the first sleep mode parameter considering at least one of the QoS of the packet service and the terminal quality by means of signaling with the terminal.

12. The sleep mode controlling method of claim 1, wherein the transiting step includes recognizing a packet service end by means of a signaling started from an application layer for the packet service, and canceling a session established for the packet service between the terminal and the cellular system.

13. The sleep mode controlling method of claim 1, further comprising establishing the second sleep mode parameter corresponding to the first sleep mode parameter according to the respective QoS of each packet service, and broadcasting the second sleep mode parameter included in the system information through a broadcasting channel.

14. The sleep mode controlling method of claim 13, wherein the second sleep mode parameter includes a staying threshold value for the transmit state, and the method further comprises:
determining whether there is packet data to be transmitted to the terminal in the transmit state or packet data to be transmitted by the terminal;
counting the staying time of the transmit state from a time point from which there is no packet data; and
transiting the terminal into a stand-by state when the staying time exceeds the staying threshold value,
wherein the terminal of the stand-by state performs a transition into the transmission state or a maintenance at the stand-by state according to the burst packet data characteristic thereby saving power.

15. The sleep mode controlling method of claim 13, wherein the second sleep mode parameter includes the staying threshold value of the idle state, and the transiting state includes transiting the terminal from the transmit state to the stand-by state, counting the staying time of the stand-by state while transiting to the stand-by state, and transiting the terminal into the idle state when the staying time exceeds the staying threshold value.

16. A method for controlling a terminal in a cellular system providing various packet services to the terminal, the terminal controlling method comprising:
ending a session of a packet service provided to the terminal and transiting the terminal to an idle state;
controlling the terminal to be operated in a first sleep duration, and
controlling the terminal to be operated in a second sleep duration, the second sleep duration rarely monitoring a paging channel compared to the first sleep duration.

17. The terminal controlling method of claim 16, wherein during the first sleep duration, the terminal monitors the paging channel whenever a first period is passed, and the first period is increased as the first sleep duration is passed, and during the second sleep duration, the terminal monitors the paging channel whenever the second sleep duration which is longer than the first sleep duration, is passed, and the second sleep duration is performed after the first sleep duration ends.

18. The terminal controlling method of claim 17, wherein the transiting step includes establishing a sleep mode parameter considering at least one of the capability of the terminal and the QoS of the packet service provided to the terminal through signaling with the terminal, and informing the sleep mode parameter to the terminal, the sleep mode parameter including the first period, first period increase value information, a second period, and a length of the first sleep duration.

19. The terminal controlling method of claim 17, further comprising establishing a sleep mode parameter according to the respective QoS of various packet services, and broadcasting the sleep mode parameter through a broadcasting channel, wherein the sleep mode parameter includes the first period, first period increase value information, a second period, and a length of the first sleep duration.

20. The terminal controlling method of claim 17, wherein during the first sleep duration, the first period is increased after the paging channel monitoring is repeated a predetermined number of times.

21. A sleep mode controlling apparatus of a cellular system providing various packet services to a terminal, the sleep mode controlling apparatus comprising:
a state controller for transiting the terminal from an active state to an idle state and controlling the terminal to perform a sleep mode operation in the idle state, and
a parameter setting unit for establishing at least one parameter necessary for the sleep mode operation based on a quality of service (QoS) of the packet service provided to the terminal when the terminal is transited into the idle state.

22. The sleep mode controlling apparatus of claim 21, wherein the parameter setting unit establishes the at least one parameter considering the terminal capability.

23. The sleep mode controlling apparatus of claim 21, wherein the at least one parameter includes a first parameter for a first sleep duration and a second parameter for a second sleep duration, and the terminal monitors a paging channel whenever a first period is passed during the first sleep duration, and monitors the paging channel whenever a second period, longer than the first period, is passed during the second sleep duration after the first sleep duration ends.

24. The sleep mode controlling apparatus of claim 21, wherein the at least one parameter includes an increase value of a first period and an increase coefficient of the first period, and when the first period is increased, the increased first period is determined by summing the previous first period and a product of the increase value and the increase coefficient.

25. A base station of a cellular system comprising a controller for controlling a sleep mode of claim 21.

26. The base station of claim 25, wherein the cellular system is a 3rd Generation Partnership Project (3GPP) system.

27. A method for performing a sleep mode operation for a terminal provided various packet services from a cellular system, the sleep mode operation performing method comprising:
receiving a sleep mode parameter determined according to QoS of the packet service,
monitoring a paging channel each time a first period is passed, the first period being determined by the sleep mode parameter during a first sleep duration, and
monitoring the paging channel each time a second period is passed, the second period being determined by the sleep mode parameter during a second sleep duration after the established first sleep duration ends.

28. The sleep mode operation performing method of claim 27, wherein the sleep mode parameter is determined by signaling considering at least one of the capability of the terminal and the QoS of the packet service provided before the performing of the sleep mode operation to the terminal through the signaling with the cellular system.

29. The sleep mode operation performing method of claim 27, wherein the receiving step includes receiving the sleep mode parameter established according to the QoS of the various packet services through a broadcasting channel.

30. The sleep mode operation performing method of claim 27, wherein the first period is increased as the first sleep duration is passed, and the second period is longer than the first period.
